(19) United States
(12) Patent Application Publication
(10) Pub. No.: US 2020/0025360 A1
(43) Pub. Date: Jan. 23, 2020

(54) ILLUMINATING LAMP AND DECORATIVE LAMP

(71) Applicant: Shangyou Jiayi Lighting Product Co., Ltd., Ganzhou (CN)

(72) Inventor: Yaowen He, Ganzhou City (CN)

(21) Appl. No.: 16/519,759

(22) Filed: Jul. 23, 2019

(30) Foreign Application Priority Data
Jul. 23, 2018 (CN) 201821170348.5

(51) Int. Cl. F21V 23/00

(52) U.S. Cl. CPC F21V 23/002; F21Y 2115/10

(57) ABSTRACT

The present disclosure relates to the technical field of illuminating lamps, in particular to an illuminating lamp and a decorative lamp. The illuminating lamp includes: a lamp body, an insulation layer and at least two wires arranged in parallel, wherein the at least two wires arranged in parallel are provided inside the insulation layer, and the insulation layer, after being polished, forms a welding zone for welding the lamp body; the lamp body is welded at the same sides of the at least two wires, and the lamp body is welded on surfaces of the wires by welding layers. The decorative lamp includes the above illuminating lamp.

### CROSS-REFERENCE TO RELATED APPLICATION

The present application claims the priority benefit of Chinese patent application with the filing number 201821170348.5 filed on Jul. 23, 2018 with the Chinese Patent Office (CNIPA), and entitled “Illuminating Lamp and Decorative Lamp”, the contents of which are incorporated herein by reference in entirety.

### TECHNICAL FIELD

The present disclosure relates to the technical field of illuminating lamps, in particular to an illuminating lamp and a decorative lamp.

### BACKGROUND ART

In recent years, semiconductor light-emitting components have gradually replaced conventional illuminating devices. Although an LED lamp has many advantages, due to its characteristics of low voltage and low current, it also has disadvantages. Generally, in order to increase luminance of the LED lamp, many LED lamps are combined to form one illuminating device or a string light. Existing string lights are usually formed by welding multiple LED lamps on a metal wire, or LED lamp chips are electrically connected with the metal wire directly.

In the prior art, however, it is difficult to carry out a connection operation on a small-volume thin metal wire; at present, all the LED lamps are clamped, in a 90° orientation, between two strings (threads) that are already polished, and then glue is dropped to wrap lamp beads. A light-emitting direction of each lamp bead is parallel to the strings, and light from a light source only can be diffused towards one direction, thus the effect of diffusion is poor, moreover, their string material has to be transparent, and if an opaque string material is used, light from the light source cannot be diffused very well. Moreover, the LED lamps should be clamped one by one between the two strings, resulting in more time spent in manufacturing.

Information disclosed in the part of Background Art only aims at deepening understanding to the overall background art of the present disclosure, but should not be regarded as acknowledging or implying in any form that the information constitutes prior art generally known by those skilled in the art.

### SUMMARY

The present disclosure provides an illuminating lamp, including: a lamp body(s), an insulation layer and at least two wires arranged in parallel, wherein the at least two wires arranged in parallel are provided inside the insulation layer, and the insulation layer, after being polished, forms a welding zone(s) for welding the lamp body(s); and the lamp body is welded at the same sides of the at least two wires, and the lamp body is welded on surfaces of the wires by means of welding layers.

The present disclosure further provides a decorative lamp, including the above illuminating lamp.

### BRIEF DESCRIPTION OF DRAWINGS

In order to more clearly illustrate technical solutions in embodiments of the present disclosure or in the prior art, accompanying drawings which need to be used for description of the embodiments or the prior art will be introduced briefly below, and apparently, the accompanying drawings in the description below merely show some embodiments of the present disclosure, and those ordinarily skilled in the art still could obtain other accompanying drawings in light of these accompanying drawings, without using inventive effort.

FIG. 1 is a structural schematic diagram of an illuminating lamp provided in an embodiment of the present disclosure; and

FIG. 2 is a sectional view of the illuminating lamp provided in an embodiment of the present disclosure.

### REFERENCE SIGNS

100—lamp body; 200—welding layer; 300—wire; 400—insulation layer; 500—conductive layer.

### DETAILED DESCRIPTION OF EMBODIMENTS

Technical solutions of the present disclosure will be described below clearly and completely in connection with accompanying drawings. Apparently, the embodiments described are only some embodiments of the present disclosure, rather than all embodiments. All other embodiments, obtained by those ordinarily skilled in the art based on the embodiments of the present disclosure without using inventive efforts, shall fall within the scope of protection of the present disclosure.

In the description of the present disclosure, it should be indicated that orientational or positional relations indicated by terms “center”, “upper”, “lower”, “left”, “right”, “vertical”, “horizontal”, “inner”, “outer” and so on are based on orientational or positional relations as shown in the accompanying drawings, merely for facilitating the description of the present disclosure and simplifying the description, rather than indicating or implying that related devices or elements have to be in the specific orientation or configured and operated in a specific orientation, therefore, they should not be construed as limitations on the present disclosure. Besides, terms “first” and “second” are merely for descriptive purpose, but should not be construed as indicating or implying relative importance.

In the description of the present disclosure, it should be indicated that unless otherwise specified and defined explicitly, terms “mount”, “join”, and “connect” should be construed in a broad sense. For example, it may be fixed connection, detachable connection, or integral connection; it may be mechanical connection, and also may be electrical connection; it may be direct connection, indirect connection via an intermediate medium, or inner communication between two elements. For those ordinarily skilled in the art, specific meanings of the above-mentioned terms in the present disclosure can be understood according to specific circumstances.

The present disclosure is further described in detail below by specific embodiments in connection with accompanying drawings.

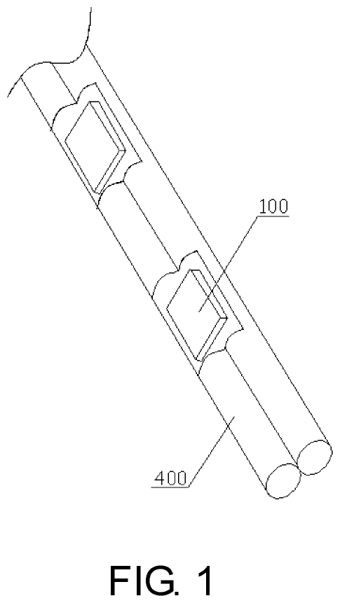

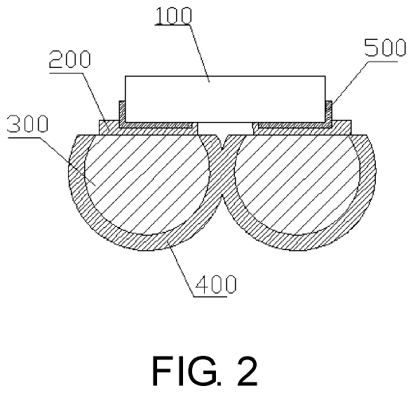

As shown in FIG. 1 and FIG. 2, an illuminating lamp provided in the present disclosure includes lamp bodies 100, an insulation layer 400 and at least two wires 300 arranged in parallel, wherein the at least two wires 300 arranged in parallel are provided inside the insulation layer 400, and the insulation layer 400, after being polished, forms welding zones for welding the lamp bodies 100; each lamp bodies 100 is welded at the same sides of the at least two wires 300, and the lamp bodies 100 are welded on surfaces of the wires 300 by means of welding layers 200. The technical problem of poor stability and low safety in the prior art is solved.

Specifically, a positive electrode end of each lamp body 100 is electrically connected with one wire 300, a negative electrode end of the lamp body 100 is electrically connected with the other wire 300, achieving illumination by the lamp bodies 100.

Optionally, the lamp bodies 100 include LED lamps, having the advantages of safety, high luminous efficiency, and good shock resistance and good stability.

It needs to be indicated that the welding layers 200 include solder layers.

It further needs to be indicated that the wires 300 include copper wires, for conducting electricity.

It further needs to be indicated that the LED lamp is configured as a lamp bodies that can emit chromatic light or can emit light in multiple colors; therefore, it does not need to coat a colored colloid layer on an outer surface of the LED lamp, thus bringing the advantage of saving raw materials.

In an optional solution of the present embodiment, a protective layer is provided outside the colloid layer, functioning to protect the colloid layer and the lamp body 100.

Specifically, the protective layer is configured as a transparent protective layer, and the arrangement of the transparent protective layer will not affect light emission of the lamp body 100.

In an optional solution of the present disclosure, a bottom portion of the lamp body 100 is further provided with conductive layers 500, wherein the conductive layers 500 are located between the lamp body 100 and the respective welding layers 200.

Specifically, an insulation coating is provided at a gap formed by the lamp body 100 and the insulation layer 400 and provided outside the conductive layers exposed to the outside, which can avoid electric leakage.

It needs to be indicated that the whole illuminating lamp is externally wrapped by a transparent decorative layer, further avoiding electric leakage.

It further needs to be indicated that an ultraviolet-proof layer is further provided outside the transparent decorative layer, prolonging the outdoor service life of the illuminating lamp.

It can be seen through combination of the above detailed description of the present disclosure that the illuminating lamp provided in the present embodiment solves the technical problem of poor diffusion of a light source in the prior art, and includes the lamp bodies 100, the insulation layer 400 and the at least two wires 300 arranged in parallel, wherein the at least two wires 300 arranged in parallel are provided inside the insulation layer 400, and the insulation layer 400, after being polished, forms welding zones for welding the lamp bodies 100; each lamp bodies 100 is welded at the same sides of the at least two wires 300, and the lamp bodies 100 are welded on the surfaces of the wires 300 by means of the welding layers 200. In manufacturing, the lamp bodies 100 are directly attached to on surfaces of the polished and tinned wires 300, the lamp bodies 100 and the wires 300 are welded by a reflow welding machine, then the lamp bodies 100 are wrapped by the colloid layers, and the colloid layers are baked to be solidified; since each lamp bodies 100 is at the same sides of the at least two wires 300, 360° light emission can be achieved using the lamp body 100, such that light from the light source can be diffused all around; moreover, the insulation layer 400 can be polished, such that each one lamp body 100 is corresponding to one respective welding zone, thus bringing the advantages of a simple structure, practical function, and quick manufacturing, meanwhile, the color of the insulation layer 400 is not limited, and it is not necessarily to be of a transparent material, therefore, a light-emitting angle and a light diffusing range can be broader. Therefore, the technical problem of poor stability and low safety in the prior art is solved.

The decorative lamp provided in the present embodiment includes the above illuminating lamp solving the technical problem of poor diffusion of a light source in the prior art.

The decorative lamp provided in the present embodiment includes the above illuminating lamp. Due to the configuration of the illuminating lamp, the decorative lamp has all the advantages of the above illuminating lamp; since each lamp body 100 is at the same sides of the at least two wires 300, 360° light emission can be achieved using the lamp body 100, such that light from the light source can be diffused all around; moreover, the insulation layer 400 can be polished, such that each one lamp body 100 is corresponding to one respective welding zone, thus having the advantages of a simple structure, practical function, and quick manufacturing, meanwhile, the color of the insulation layer 400 is not limited, and it is not necessarily to be of a transparent material, therefore, a light-emitting angle and a light diffusing range can be broader.

Finally, it should be explained that the various embodiments above are merely used for illustrating the technical solutions of the present disclosure, rather than limiting the present disclosure. While the detailed description is made to the present disclosure with reference to various preceding embodiments, those ordinarily skilled in the art should understand that they still could modify the technical solutions recited in various preceding embodiments, or make equivalent substitutions to some or all of the technical features therein. These modifications or substitutions do not make the corresponding technical solutions essentially depart from the scope of the technical solutions of the various embodiments of the present disclosure.

Besides, those skilled in the art could understand that although some embodiments described herein include certain features included in other embodiments rather than other features, combinations of features in different embodiments mean that they fall within the scope of the present disclosure and form different embodiments. For example, in the following claims, any of the embodiments claimed to protect can be used in any combination manner. Information disclosed in the part of Background Art only aims at deepening understanding to the overall background art of the present disclosure, but should not be regarded as acknowledging or implying in any form that the information constitutes prior art generally known by a person skilled in the art.

### INDUSTRIAL APPLICABILITY

360° light emission can be achieved using the lamp bodies in the present disclosure, such that light from the light sources can be diffused all around; moreover, the insulation layer can be polished, such that each one lamp body is corresponding to one respective welding zone, thus having the advantages of a simple structure, practical function, and quick manufacturing, meanwhile, the color of the insulation layer is not limited, and it is not necessarily to be of a transparent material, therefore, the light-emitting angle and the light diffusing range can be broader.

What is claimed is:

1. An illuminating lamp, comprising: a lamp body(s), an insulation layer and at least two wires arranged in parallel, wherein the at least two wires arranged in parallel are provided inside the insulation layer, and the insulation layer, after being polished, forms a welding zone(s) for welding the lamp body(s); and
each lamp body is welded at same sides of the at least two wires, and the lamp body is welded on surfaces of the wires by means of welding layers.

2. The illuminating lamp according to claim 1, wherein the wires can be bent towards a back face of each welding zone.

3. The illuminating lamp according to claim 1, wherein each one lamp body is corresponding to one respective welding zone.

4. The illuminating lamp according to claim 1, wherein a positive electrode end of the lamp body is electrically connected with one wire, and a negative electrode end of the lamp body is electrically connected with the other wire.

5. The illuminating lamp according to claim 1, wherein the lamp body is capable of emitting chromatic light or capable of emitting light in multiple colors.

6. The illuminating lamp according to claim 1, wherein the lamp body comprises an LED lamp.

7. The illuminating lamp according to claim 1, wherein a colloid layer is further wrapped outside the lamp body, and a protective layer is provided outside the colloid layer.

8. The illuminating lamp according to claim 7, wherein the protective layer is configured as a transparent protective layer.

9. The illuminating lamp according to claim 1, wherein a bottom portion of the lamp body is further provided with conductive layers, and the conductive layers are located between the lamp body and the respective welding layers.

10. The illuminating lamp according to claim 9, wherein an insulation coating is provided at a gap formed by the lamp body and the insulation layer and provided outside the conductive layers exposed to the outside.

11. The illuminating lamp according to claim 1, wherein the welding layers comprise solder layers.

12. The illuminating lamp according to claim 1, wherein the wires comprise copper wires.

13. The illuminating lamp according to claim 1, wherein the whole illuminating lamp is externally wrapped by a transparent decorative layer.

14. The illuminating lamp according to claim 13, wherein an ultraviolet-proof layer is further provided outside the transparent decorative layer.

15. A decorative lamp, comprising the illuminating lamp according to claim 1.

16. The illuminating lamp according to claim 2, wherein each one lamp body is corresponding to one respective welding zone.

17. The illuminating lamp according to claim 2, wherein a positive electrode end of the lamp body is electrically connected with one wire, and a negative electrode end of the lamp body is electrically connected with the other wire.

18. The illuminating lamp according to claim 3, wherein a positive electrode end of the lamp body is electrically connected with one wire, and a negative electrode end of the lamp body is electrically connected with the other wire.

19. The illuminating lamp according to claim 2, wherein the lamp body is capable of emitting chromatic light or capable of emitting light in multiple colors.

20. The illuminating lamp according to claim 3, wherein the lamp body is capable of emitting chromatic light or capable of emitting light in multiple colors.
